(19) United States
(12) Patent Application Publication
(10) Pub. No.: US 2009/0080114 A1
(43) Pub. Date: Mar. 26, 2009

(54) Head gimbal assembly, flexible printed cable, head stack assembly, and disk drive unit with the same

(75) Inventors: Ming Gao Yao, Dong Guan (CN); Yu Sun, Dong Guan (CN); Yiru Xie, Dong Guan (CN)

Correspondence Address: NIXON & VANDERHYE, PC, 901 NORTH GLEBE ROAD, 11TH FLOOR, ARLINGTON, VA, 22203, US

(73) Assignee: SAE Magnetics (H.K.) Ltd., Hong Kong (CN)

(21) Appl. No.: 11/902,412

(22) Filed: Sep. 21, 2007

(51) Int. Cl. G11B 5/48

(52) U.S. Cl. 360/245.3

(57) ABSTRACT

A head gimbal assembly comprises a micro-actuator and a suspension. The suspension provides a single channel electrically connecting a bonding terminal of the suspension with the micro-actuator for controlling the movement of the micro-actuator. Thus the head gimbal assembly has a simple layout of a single channel to control the micro-actuator. The present invention also discloses a head gimbal assembly avoiding the occurrence of cross-talk, a flexible printed cable utilizing a common voltage lead to reduce its size, a head stack assembly with alternately arranged and stacked head gimbal assemblies which reduces or even prevents suspension and arm vibration resonance as well as avoids sliders from off-track and out of TMR budget, and a disk drive unit with such head stack assembly.

### FIELD OF THE INVENTION

The present invention relates to a system of controlling a micro-actuator of an information recording disk drive device. More particularly, the present invention relates to a head gimbal assembly (HGA) with a micro-actuator, a flexible printed cable (FPC) for controlling the micro-actuator, a head stack assembly (HSA) with a plurality of the HGAs and a disk drive unit with the head stack assembly.

### BACKGROUND OF THE INVENTION

Disk drive is an information storage device that uses magnetic media to store data and a movable read/write head that is positioned over the media to selectively read from or write to the media.

Consumers are constantly desiring greater storage capacity for such disk drive devices, as well as faster and more accurate reading and writing operations. Thus, disk drive manufacturers have continued to develop higher capacity disk drives by increasing the recording and reproducing density of the information tracks on the disks. However, each increase in track density requires that the disk drive device have a corresponding increase in the positional control of the read/write head. As track density increases, it becomes more and more difficult to quickly and accurately position the read/write head over the desired information tracks on the disk. Thus, disk drive manufacturers are constantly seeking ways to improve the positional control of the read/write head in order to take advantage of the continual increases in track density.

One common disk drive includes a serve controller driving a voice coil motor (VCM) to position a read/write head over a desired track of a magnetic disk. Referring to FIG. 1, a conventional disk drive device using voice coil motor typically applies a head gimbal assembly 100, a drive arm 104 attached to the head gimbal assembly 100, a disk 101, and a spindle motor 102 for spinning the disk 101. The employed voice coil motor is denoted by reference number 105 and is connected to all the drive arm 104 for controlling the motion of the drive arm 104 and, in turn, controlling a slider 103 of the head gimbal assembly 100 to position with reference to data tracks across the surface of the disk 101, thereby enabling a read/write head imbedded in the slider 103 to read data from or write data to the disk 101. Thus, the voice coil motor 105 performs adjustments to the position of the read/write head. However, as voice coil motor 105 possesses limited bandwidth due to its large inertia, the position control of the read/write head with respect to the track by the voice coil motor 105 has never presented enough accuracy, and thereby the slider 103 can not attain a quick and fine position control which accordingly affects the ability of the read/write head to read data from and write data to the disk 101.

In order to solve the problem, an additional actuator mechanism, for example a piezoelectric (PZT) micro-actuator, is introduced in the head gimbal assembly of the disk drive device in order to modify the displacement of the slider. The piezoelectric micro-actuator could corrects the displacement of the slider on a much smaller scale, as compared to the voice coil motor, in order to compensate for the resonance tolerance of the voice coil motor. Generally, the micro-actuator enables, for example, the use of a smaller recording track pitch, and can increase the “tracks per inch” (TPI) value by 50% for the disk drive unit, as well as provide an advantageous reduction in the head seeking and settling time. FIGS. 2a-2d illustrate a first conventional head gimbal assembly 200 and FIGS. 3a-3c illustrate a second conventional head gimbal assembly 300.

Referring to FIG. 2a, the first conventional head gimbal assembly 200 has a suspension 230 to suspend a slider 210 thereon. A piezoelectric micro-actuator 220 is mounted on a tongue of the suspension 230 and partially incorporates the slider 210. The slider 210 is electrically coupled to suspension outer traces 232 via four electrical connection balls 208. Further, the suspension provides two suspension inner traces 233 which are both electrically connected to the micro-actuator 220. As is best shown in FIG. 2b, the suspension 230 forms three pads 232a, 232b, 232c at each side thereof and the micro-actuator 220 provides three pads 222a, 222b, 222c at each side thereof which are respectively connected to corresponding pads 232a, 232b, 232c of the suspension. Each of the two suspension inner traces 233 is electrically connected to the pads 222b and 222c of each side of the micro-actuator 220 for receiving control signal, thus the first conventional head gimbal assembly 200 forms two operation channels for controlling the movement of the micro-actuator.

Referring to FIGS. 2c and 2d, the micro-actuator 220 comprises a U-shaped frame 221 which comprises two side beams 221a, 221b. The side beam 221a, 221b each has a piezoelectric element. The slider 210 is mechanically connected with the two side beams 221a, 221b of the micro-actuator 220 by epoxy 212 at bonding points 211 of the slider 210. The bottom of the U-shape frame 221 is attached to the tongue of the suspension 230 (shown in FIG. 2a). The slider 210 and the frame 221 mutually form a rectangular hollow structure. The slider 210 and the side beams 221a, 221b are not directly connected to the tongue of the suspension 230 and thus enable the slider 210 and the side beams 221a, 221b to move freely with respect to the tongue of the suspension 230. When an actuating voltage is applied through the two suspension inner traces 233 to the two piezoelectric elements of the micro-actuator 220, one piezoelectric element will expand while the other piezoelectric element will contract, causing the beams 221a, 221b to bend in a common lateral direction, thus the initial rectangular hollow structure becomes approximately a parallelogram, leading the slider 210 to undergo a lateral translation, through which successfully adjusts the slider's position.

Referring to FIG. 3a, the second head gimbal assembly 300 comprises a slider 310, a micro-actuator 320 and a suspension 330 to support the slider 310 and the micro-actuator 320. Specifically, the suspension provides a plurality of suspension outer traces 332 to electrically connect with the slider 310 and forms three pads 332a, 332b, 332c and two suspension inner traces 333 for establishing electrical connection with the micro-actuator 320. As seen in FIG. 3b, the micro-actuator 320 comprises two piezoelectric elements 320a, 320b of same polarization direction. Three pads 322a, 322b, 322c are provided on one side of the PZT elements 320a, 320b. Here, the middle pad 322b is a ground pad shared by the two PZT elements 320a, 320b and the two pads 322a, 322c are used for inputting active signals. The three pads 322a, 322b, 322c of the micro-actuator are respectively connected to the corresponding three pads 332a, 332b, 332c of the suspension 330 for establishing electrical connection therebetween. The two suspension inner traces 333 are respectively and electrically connected to the pad 332a, 332c of the micro-actuator 220 for receiving control signal from a flexible printed cable of an external control system, thus the second conventional head gimbal assembly 300 also forms two operation channels for controlling the movement of the micro-actuator 320.

Referring to FIG. 3c, because the two piezoelectric elements 320a, 320b have same polarization direction, once a sine actuating voltage in opposite phase is inputted, the micro-actuator 320 will be electrically stimulated and produce piezoelectric effect, thus one piezoelectric element 320a contracts and the other piezoelectric element 320b extends, which generates a rotation torque to cause the slider 310 to rotate.

However, when regarding to the whole structure of the head gimbal assembly 200/300 of the prior technology, it is recognized that the micro-actuator 220/320 and the suspension 230/330 of the head gimbal assembly 200/300 are both complex in structure. That is, the micro-actuator 210/310 forms at least three pads and the suspension 230/330 accordingly needs to provide at least three pads for electrical connection with the micro-actuator 210/310. Moreover, the suspension 230/330 forms two operation channels with two suspension inner traces 233/333 for electrically connecting the micro-actuator 220/320 with the flexible printed cable. Moreover, the dual operation channels for the micro-actuator 220/320 need a complex drive generator for the full hard disk drive (HDD) to provide the sine actuating voltage in opposite phase and also a complex printed circuit board assembly (PCBA) design and manufacture. All of the above-mentioned features lead the head gimbal assembly 200/300 complex in trace and pad layout, more components and its control circuit, which accordingly, not only increase the manufacturing cost but also complicates the fabrication process.

In addition, as in the prior art, the inner traces 233/333 are intermixed among read traces and write traces of the suspension outer traces 232/332, high-voltage signal inputted into the inner traces 233/33 will adversely induce cross-talk between the read traces of the suspension outer traces 232/332 and the inner traces 233/333, which could weaken quality of signal transmitted into the slider 210/310 as well as the micro-actuator 220/320 and accordingly badly affect the operation characteristics of the head gimbal assembly 200/300.

Moreover, as the flexible printed cable need to provide multiple voltage leads to drive or simulate respective two piezoelectric elements of the micro-actuator 220/320, which not only takes large space and makes a bulky size, but also wastes electricity resource.

Finally, once the micro-actuator 220/320 is driven, the PZT elements of the micro-actuator 220/320 will be excited to move and according lead the slider 210/310 to translate. The translation of the slider 210/310 generates a lateral inertia force, and the lateral inertia force will adversely causes a vibration resonance on suspension 230/330, which in turn, drives an off-track motion of the slider 210/310, finally making the head out of TMR (Track Mis-Registration) budget. Moreover, because of the requirement of progressively miniaturized size and large storage capacity, head stack assembly equipped with a plurality of head gimbal assemblies has gained a wide popularity. Because every two head gimbal assemblies are mounted to a common drive arm, and because each head gimbal assembly has provided with a corresponding micro-actuator, thus when operating all these micro-actuators, the micro-actuators in the two head gimbal assemblies will move in the same direction, for example outward or toward their respective disks. The same-direction motion will couple and interact together, thus causing extraordinarily serious vibration on the corresponding drive arm, which further leads the sliders to be off-track and out of TMR budget. This, accordingly, seriously affects the dynamic performance of each head gimbal assembly and limits the servo band width and the capacity improvement of the disk drive.

Hence, a need has arisen for providing a head gimbal assembly, a flexible printed cable, a head stack assembly and a disk drive unit to overcome the above-mentioned disadvantages.

### SUMMARY OF THE INVENTION

Accordingly, an object of the present invention is to provide a head gimbal assembly with a simple layout of minimum channel and pads.

Another object of the present invention is to provide a head gimbal assembly avoiding the occurrence of cross-talk.

Still another object of the present invention is to provide a flexible printed cable with a simple layout of leads for saving space and reducing size of the flexible printed cable.

Yet another object of the present invention is to provide a head stack assembly which not only possesses a simple layout of minimum channel and pads but also reduces or even prevents suspension vibration resonance and arm vibration resonance as well as avoids sliders in the head stack assembly from off-track and out of TMR budget.

Still another object of the present invention is to provide a disk drive unit with a simple structure and a sound performance.

To achieve above objects, a head gimbal assembly comprises a micro-actuator with two piezoelectric elements of opposite polarization and a suspension. The suspension has a top portion and a tail portion. The micro-actuator is disposed on the top portion. The tail portion has a bonding terminal adapted for establishing electrical connection with a flexible printed cable. The suspension provides a single channel electrically connecting the bonding terminal with the micro-actuator for controlling the movement of the micro-actuator.

As an embodiment of the present invention, the micro-actuator provides only two pads respectively formed on corresponding piezoelectric elements and both electrically connected with the bonding terminal thus forming the single channel.

As another embodiment of the present invention, the micro-actuator provides a ground pad and a signal-input pad respectively formed on corresponding piezoelectric elements, and the bonding terminal provides only one signal-control lead, and the single channel is formed by electrically connecting the signal-control lead of the bonding terminal with the signal-input pad of the micro-actuator.

In the invention, the bonding terminal further provides a slider flying height adjustment lead, a pair of read differential leads and a pair of write differential leads, and the signal-control lead is laminated between the pair of write differential leads.

A head gimbal assembly comprises a slider, a micro-actuator with two piezoelectric elements of opposite polarization, and a suspension. The suspension has a top portion and a tail portion. The slider and the micro-actuator are disposed on the top portion. The tail portion has a bonding terminal adapted for establishing electrical connection with a flexible printed cable. The bonding terminal provides a signal-control lead, a slider flying height adjustment lead, a pair of read differential leads and a pair of write differential leads. The signal-control lead is electrically connected to the micro-actuator. The slider flying height adjustment lead, the pair of read differential leads and the pair of write differential leads are electrically connected to the slider respectively. The signal-control lead is laminated between the pair of write differential leads.

As an embodiment of the present invention, the bonding terminal has three windows. One window accommodates the pair of read differential leads, another window accommodates one of the pair of write differential leads and the slider flying height adjustment lead, and still another window accommodates the other write differential lead and the signal-control lead.

The present invention provides a flexible printed cable adapted for connecting a group of stacked head gimbal assemblies with a control system. Each head gimbal assembly has a micro-actuator. The flexible printed cable comprises a top portion, an end portion opposite the top portion for connecting to the control system, and one common voltage lead for transmitting micro-actuator drive voltage. The top portion has a plurality of connection terminals adapted for connecting to the respective head gimbal assemblies. The connection terminals each have a signal-control pad adapted for establishing electrical connection with the corresponding micro-actuator. All of the signal-control pads of the connection terminals are connected to the common voltage lead.

In embodiments of the invention, each of the connection terminals further has a slider flying height adjustment pad, a pair of read differential pads, and a pair of write differential pads.

Preferably, each of the connection terminals has three windows, one window accommodates the pair of read differential pads, another window accommodates one of the pair of write differential pads and the slider flying height adjustment pad, and still another window accommodates the other write differential pad and the signal-control pad.

A head stack assembly comprises a plurality of drive arms, a group of up-face head gimbal assemblies facing upward, a group of down-face head gimbal assemblies facing downward, and a flexible printed cable for electrically controlling the operation of all the head gimbal assemblies. The up-face and the down-face head gimbal assemblies are connected to the drive arms in such a manner that the up-face head gimbal assemblies and the down-face head gimbal assemblies are alternately arranged and stacked. Each of the head gimbal assembly comprises a slider, a micro-actuator with two piezoelectric elements of opposite polarization, and a suspension having a top portion and a tail portion. The slider and the micro-actuator are disposed on the top portion. The tail portion has a bonding terminal electrically connected with the flexible printed cable. The suspension provides a single channel electrically connecting the bonding terminal with the micro-actuator. The up-face head gimbal assemblies and the down-face head gimbal assemblies have a relation that if align the up-face head gimbal assemblies and the down-face head gimbal assemblies in the same direction, the piezoelectric elements and the channels of all the head gimbal assemblies are same.

A disk drive unit comprises a head stack assembly, a stack of disks, a spindle motor operable to spin the disks. The head stack assembly comprises a plurality of drive arms, a group of up-face head gimbal assemblies facing upward, a group of down-face head gimbal assemblies facing downward, and a flexible printed cable for electrically controlling the operation of all the head gimbal assemblies. The up-face and the down-face head gimbal assemblies are connected to the drive arms in such a manner that the up-face head gimbal assemblies and the down-face head gimbal assemblies are alternately arranged and stacked. Each of the head gimbal assembly comprises a slider, a micro-actuator with two piezoelectric elements of opposite polarization, and a suspension having a top portion and a tail portion. The slider and the micro-actuator are disposed on the top portion. The tail portion has a bonding terminal electrically connected with the flexible printed cable. The suspension provides a single channel electrically connecting the bonding terminal with the micro-actuator. The up-face head gimbal assemblies and the down-face head gimbal assemblies have a relation that if align the up-face head gimbal assemblies and the down-face head gimbal assemblies in the same direction, the piezoelectric elements and the channels of all the head gimbal assemblies are same.

In comparison with the prior art, as the head gimbal assembly employs a single channel to control the movement of the micro-actuator, and the micro-actuator forms only two pads to form the single channel, thus the head gimbal assembly possesses a simple layout. Therefore, the head gimbal assembly has a simple layout of minimum channel and pads.

In addition, the head gimbal assembly of the present invention make the signal-control lead to be laminated between the pair of write differential leads, thus the write differential leads will works as a shield which prevent the signal conducting to the micro-actuator from coupling to the read differential leads, advantageously reducing or preventing cross-talk between the read differential leads and the signal-control lead, therefore operational performance of the head gimbal assembly is optimized.

Moreover, as the flexible printed cable utilizes a common voltage lead to connect all the signal-control pads of the connection terminals for simultaneously transmitting micro-actuator drive voltage, thus the flexible printed cable has a simple layout of leads for saving space, and the size of the flexible printed cable can be reduced.

Finally, as the up-face head gimbal assemblies and the down-face head gimbal assemblies have a relation that if align the up-face head gimbal assemblies and the down-face head gimbal assemblies in the same direction, the piezoelectric elements and the channels of all the head gimbal assemblies are same, thus when operating the micro-actuators of all the head gimbal assemblies, the micro-actuator of each up-face head gimbal assembly will rotate in oppose direction against the micro-actuator of each down-face head gimbal assemblies. Accordingly, the rotation forces in oppose direction cancel each other, which prevents suspension vibration resonance and arm vibration resonance, thus significantly avoiding the sliders from off-track and out of TMR budget.

Other aspects, features, and advantages of this invention will become apparent from the following detailed description when taken in conjunction with the accompanying drawings, which are a part of this disclosure and which illustrate by way of example, principles of this invention.

### BRIEF DESCRIPTION OF THE DRAWINGS

The accompanying drawings facilitate an understanding of the various embodiments of this invention. In such drawings:

FIG. 1 shows a typical hard disk drive (HDD) structure with a voice coil motor for positional control of a read/write head according to a prior art;

FIG. 2a shows a typical head gimbal assembly with a micro-actuator for precise positional control of the read/write head according to a first conventional prior art;

FIG. 2b shows a tongue region of the head gimbal assembly of FIG. 2a in detail;

FIG. 2c is a perspective view of the micro-actuator shown in FIG. 2a;

FIG. 2d shows a detailed process of mounting a slider of the head gimbal assembly to the micro-actuator of FIG. 2b;

FIG. 3a shows a tongue region of a head gimbal assembly according to a second conventional prior art.

FIG. 3b is a perspective view of a micro-actuator of the head gimbal assembly shown in FIG. 3a;

FIG. 3c is a circuit diagram generally showing circuit connection relationships within the micro-actuator shown in FIG. 3b;

FIG. 4 is a perspective view of a head gimbal assembly according to a first embodiment of the present invention;

FIG. 5 is a perspective view showing a top portion of the head gimbal assembly of FIG. 4;

FIG. 6a is a perspective view of a micro-actuator of the head gimbal assembly shown in FIG. 5;

FIG. 6b is a circuit diagram generally showing circuit connection relationships within the micro-actuator shown in FIG. 6a;

FIG. 7 is a perspective view of a head gimbal assembly according to a second embodiment of the present invention;

FIG. 8a is a plan view showing a tail portion of the head gimbal assembly of FIG. 7;

FIG. 8b is an enlarged, plan view of a bonding terminal of the tail portion shown in FIG. 8a;

FIG. 9a is a plan view showing a flexible printed cable according to the present invention;

FIG. 9b is an enlarged, plan view of a top portion of the flexible printed cable of FIG. 9a;

FIG. 10 is a perspective view of a head stack assembly according to the present invention;

FIG. 11 shows a detail structure of a down-face head gimbal assembly and an up-face head gimbal assembly of the head stack assembly in FIG. 10;

FIG. 12 is a perspective view showing a top portion of the down-face head gimbal assembly of FIG. 11;

FIG. 13a is a plan view showing a tail portion of the down-face head gimbal assembly of FIG. 11;

FIG. 13b is an enlarged, plan view of a bonding terminal of the tail portion in FIG. 13a;

FIG. 14a is a plan view showing a tail portion of the up-face head gimbal assembly of FIG. 11;

FIG. 14b is an enlarged, plan view of a bonding terminal of the tail portion in FIG. 14a;

FIG. 15 is a view showing the tail portion of the down-face head gimbal assembly of FIG. 13b and the tail portion of the up-face head gimbal assembly of FIG. 14b both assembled with a top portion of the flexible printed cable shown in FIG. 9b; and

FIG. 16 is a perspective view of a disk drive unit according to the present invention.

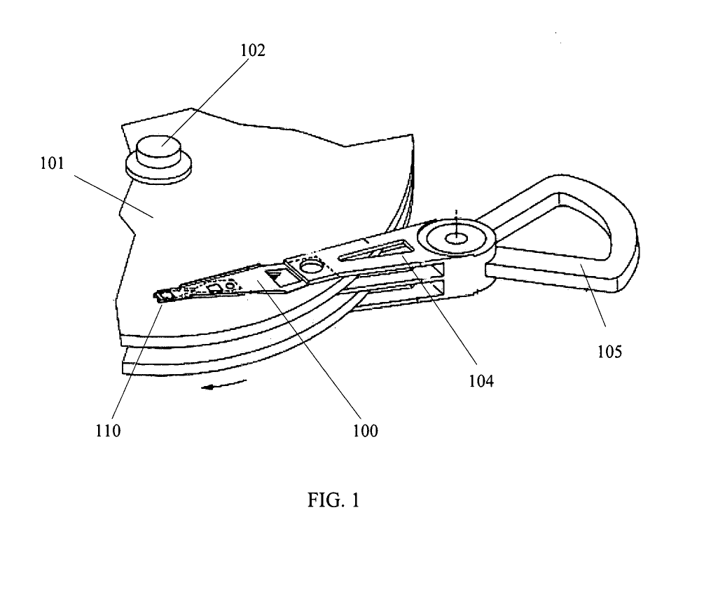

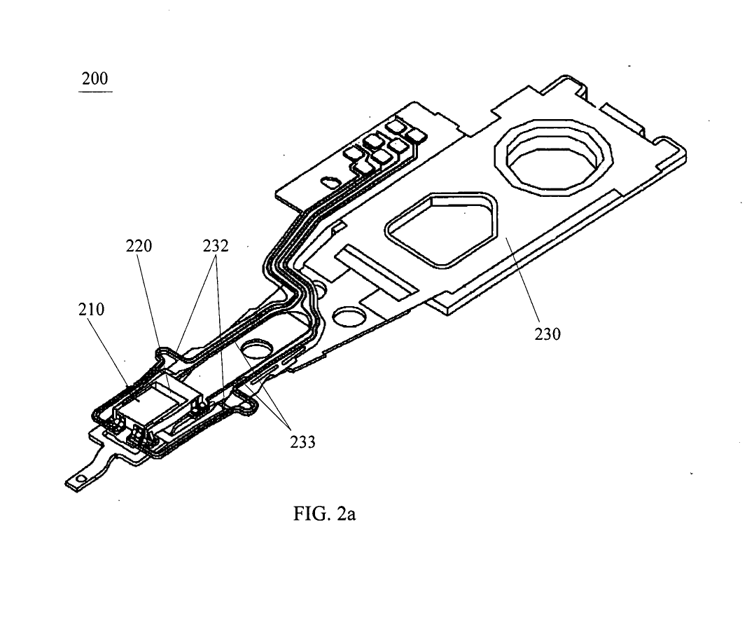

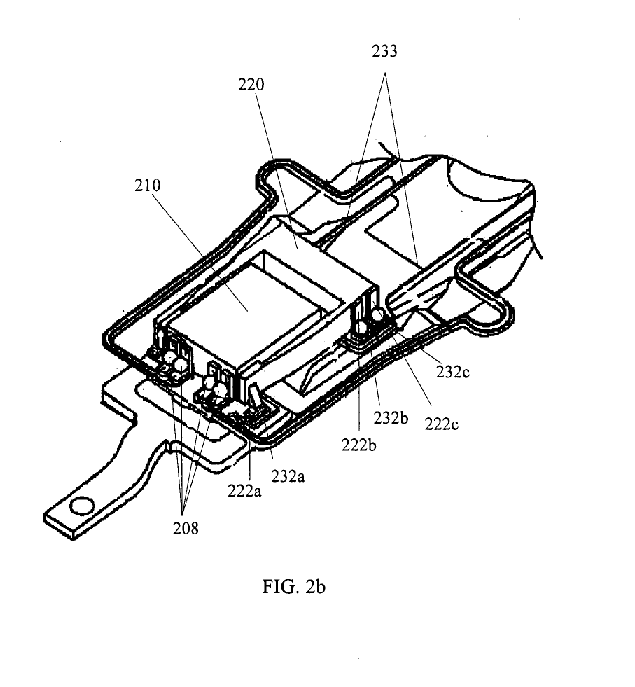

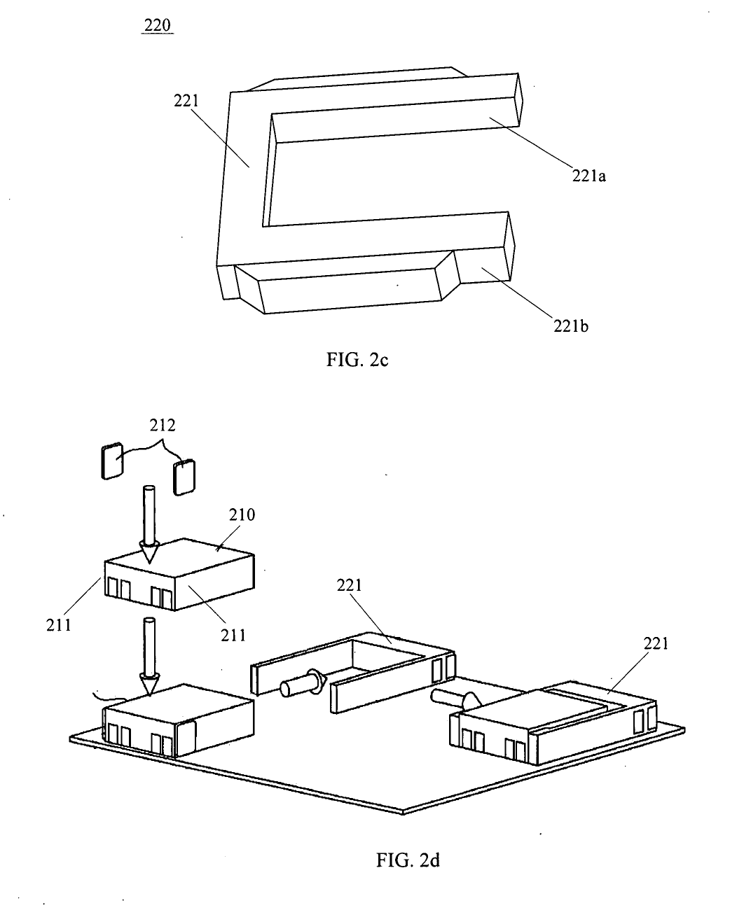

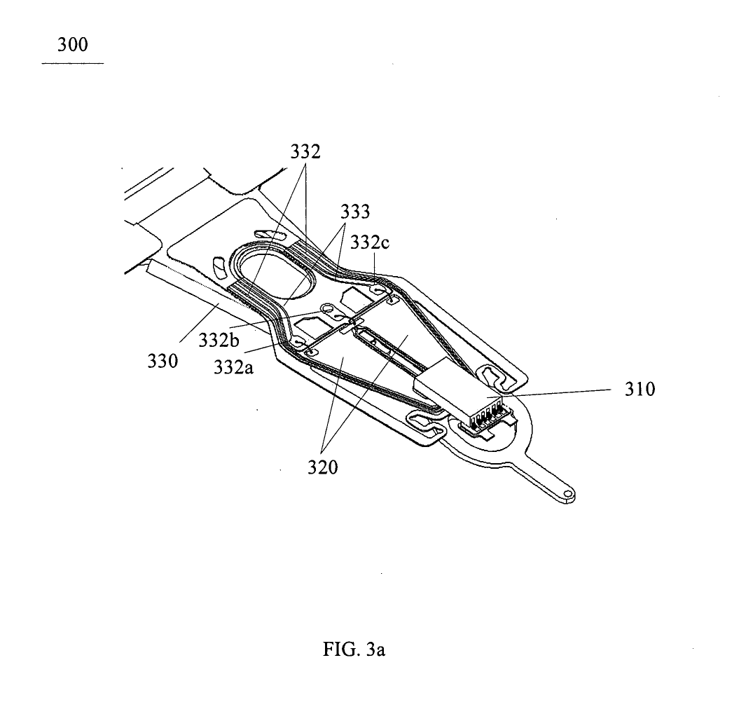

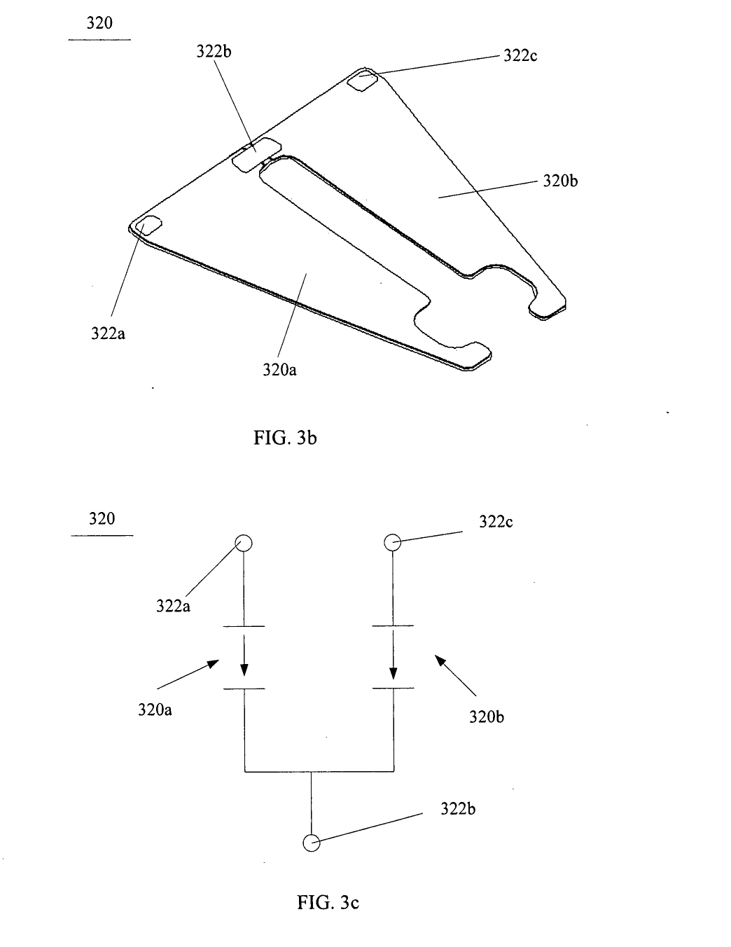

### DETAILED DESCRIPTION OF ILLUSTRATED EMBODIMENTS

Various preferred embodiments of the invention will now be described with reference to the figures, wherein like reference numerals designate similar parts throughout the various views. The present invention provides a head gimbal assembly with a simple layout of a single channel and only two pads for micro-actuator. Moreover, the present invention provides a head gimbal assembly which could avoid occurrence of cross-talk and a flexible printed cable with a common voltage lead adapted to connect all the signal-control pads which enable to reduce the size of the flexible printed cable. Besides, the present invention employs a head stack assembly with alternately arranged and stacked head gimbal assemblies, which reduces or even prevents suspension vibration resonance and arm vibration resonance as well as avoids all sliders in the head stack assembly from off-track and out of TMR budget.

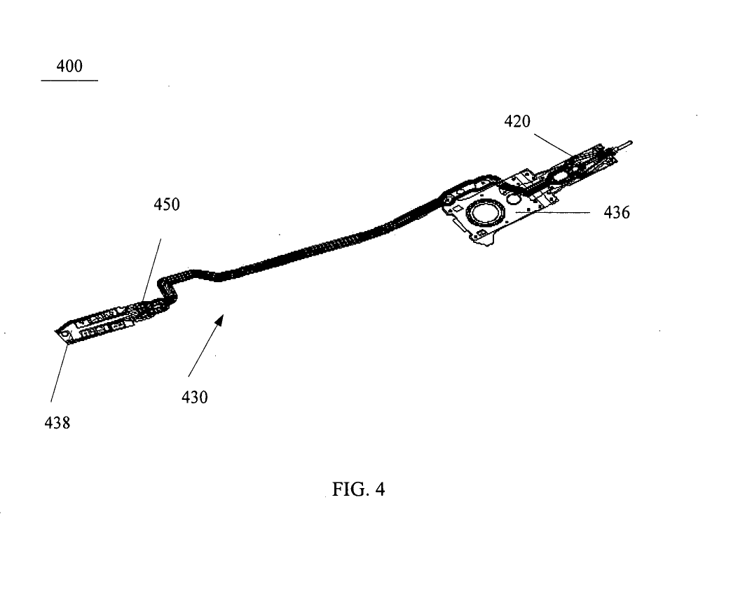

FIGS. 4-6 illustrate a head stack assembly 400 according to a first embodiment of the present invention. Referring to FIG. 4, the head gimbal assembly 400 comprises a micro-actuator 420 and a suspension 430. The suspension 430 has a top portion 436 and a tail portion 438. The tail portion 438 has a bonding terminal 450 adapted for establishing electrical connection with a flexible printed cable. The suspension 430 provides a single channel electrically connecting the bonding terminal 450 of the tail portion 438 of the suspension 430 with the micro-actuator 420 for controlling the movement of the micro-actuator 430.

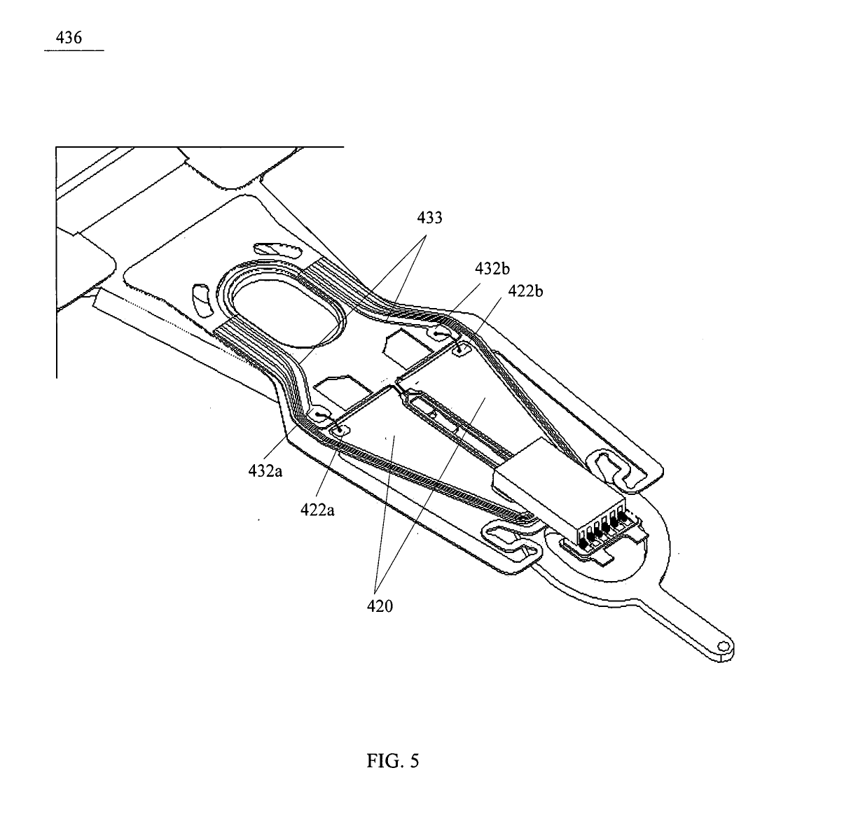

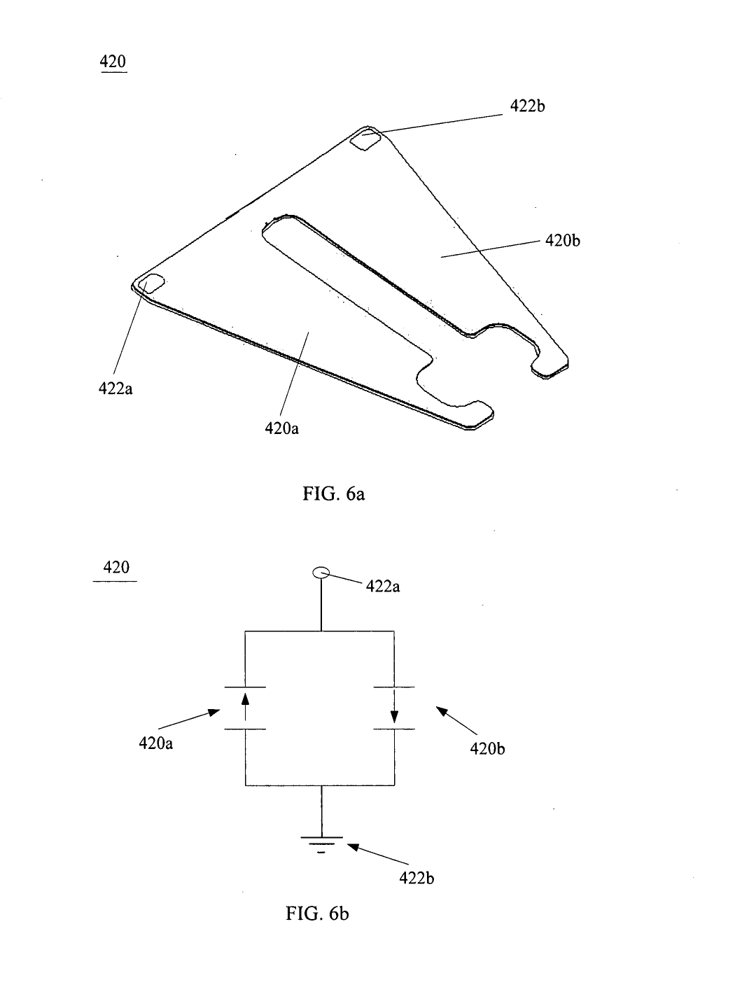

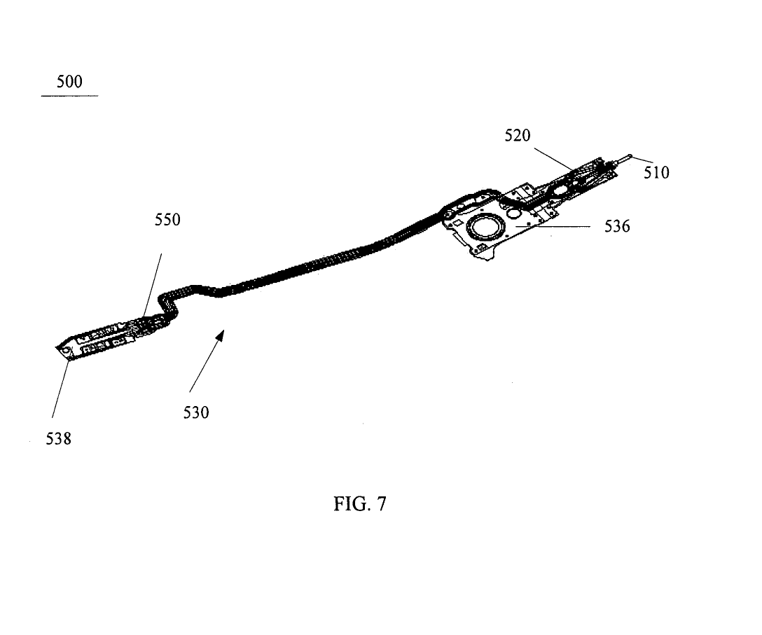

Referring to FIG. 5, the micro-actuator 420 is disposed on the top portion 436 of the suspension 430. The top portion 436 of the suspension 430 provides two pads 432a, 432b and the bonding terminal 450 of the tail portion 438 of the suspension 430 provides two suspension inner traces 433 for establishing electrical connection of the micro-actuator 420 with the flexible printed cable. Referring to FIG. 6a, the micro-actuator 420 has two piezoelectric elements 420a, 420b of opposite polarization. In addition, the micro-actuator 420 provides two pads 422a, 422b respectively formed on corresponding piezoelectric elements 420a, 420b and both electrically connected with the bonding terminal 450 of the suspension 430 via two suspension inner traces 433 thus forming the single channel. Referring to FIG. 6b, the pad 422a is electrically connected to the anode (V+) while the pad 422b is electrically connected to the cathode (V−). It is noted that the pad 422a serves as a signal-input pad and the pad 422b serves as a signal-output pad. It will be appreciated that, alternatively, the pad 422b can be grounded to serve as a ground pad. When an actuating voltage is inputted, the micro-actuator 420 will be electrically stimulated and produce piezoelectric effect. Since the two PZT elements 420a, 420b have opposite polarization direction, the piezoelectric element 420a will contract and the other piezoelectric element 420b will extend, which generates a rotation torque to cause a slider of the head gimbal assembly 400 to rotate.

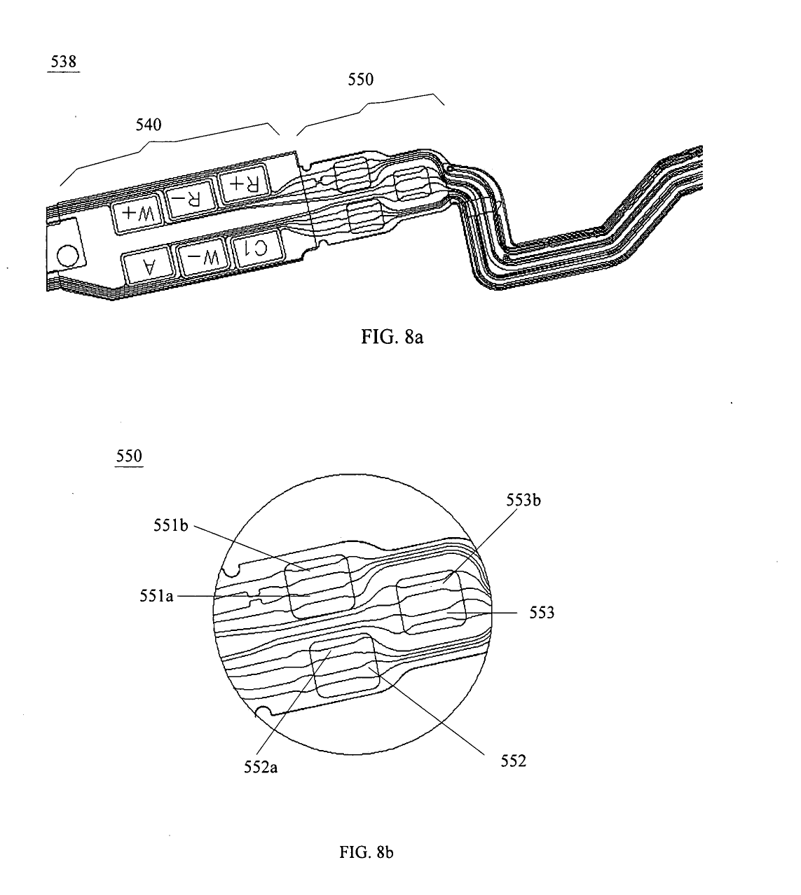

FIGS. 7, 8a and 8b illustrate a head gimbal assembly 500 according to a second embodiment of the present invention. The head gimbal assembly 500 comprises a slider 510, a micro-actuator 520 with two piezoelectric elements of opposite polarization and a suspension 530. The suspension 530 has a top portion 536 and a tail portion 538. The slider 510 and the micro-actuator 520 are disposed on the top portion 536 of the suspension 530.

Referring to FIGS. 8a and 8b, the tail portion 538 of the suspension 530 has a testing-pad terminal 540 and a bonding terminal 550. The testing-pad terminal 540 has a plurality of pads which is used for testing dynamic performance of the head gimbal assembly 500. After finishing the testing, the testing-pad portion 540 will be cut off and removed before the coupling of the tail portion 538 with a flexible printed cable. The bonding terminal 550 is adapted for establishing electrical connection with the flexible printed cable. The bonding terminal 550 provides a signal-control lead 553 (for A), a slider flying height adjustment lead 552 (for C1), a pair of read differential leads 551a (for R−), 551b (for R+) and a pair of write differential leads 553b (for W+), 552a (for W−). The signal-control lead 553 is electrically connected to the micro-actuator 520 through the inner trace 433′. The slider flying height adjustment lead 552, the pair of read differential leads 551a, 551b and the pair of write differential leads 553b, 552a are electrically connected to the slider 510 respectively. In the embodiment, the signal-control lead 553 is laminated between the pair of write differential leads 553b, 552a, separating the read differential leads 551b, 551a from the signal-control lead 553 by a distance, therefore the write differential leads 553b, 552a will work as a shield which prevents the micro-actuator drive signal from coupling to the read leads. Also the signal-control lead 553 is laminate between the read traces of read differential lead 551a, 551b and write traces of the write differential leads 553b, 552a, separating the read differential leads 551a, 551b and write differential leads 553b, 552a by a certain distance. This also helps to prevent the signal coupling cross-talk between the read differential leads 551a, 551b and write differential leads 553b, 552a during the slider reading and writing process. In this manner, cross-talk between signal-control lead 553 and the read traces as well as between the read traces and write traces are reduced or even prevented, improving signal transmission quality and achieving a better electrical performance of the head gimbal assembly 500.

Referring to FIG. 8b again, the bonding terminal 550 has three windows. One window accommodates one read differential lead 551a and the other read differential lead 551b, another window accommodates one write differential leads 552a and the slider flying height adjustment lead 552, and still another window accommodates the other write differential lead 553b and the signal-control lead 553. In such layout, the signal-control lead 553 is laminated between the pair of write differential leads 553b, 552a.

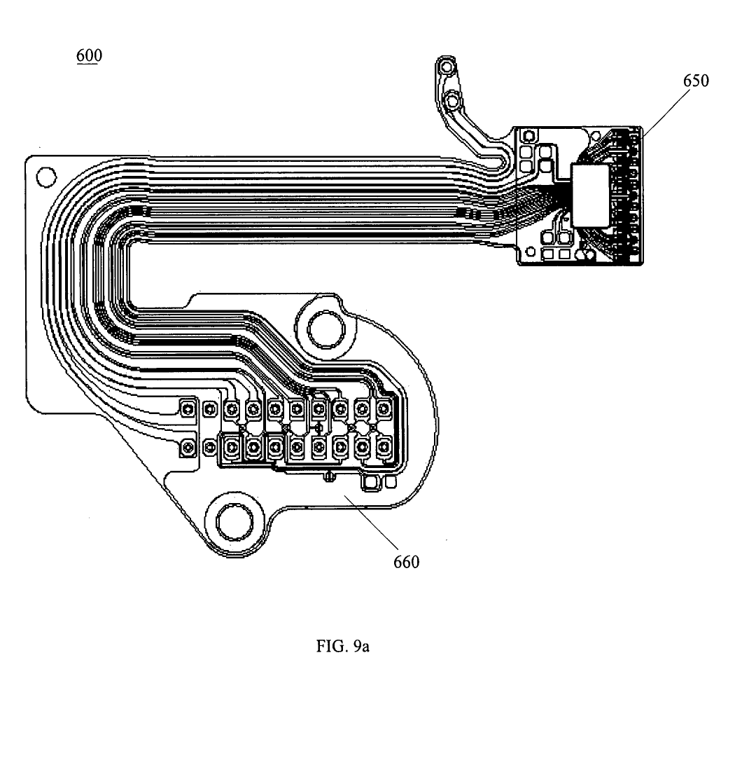

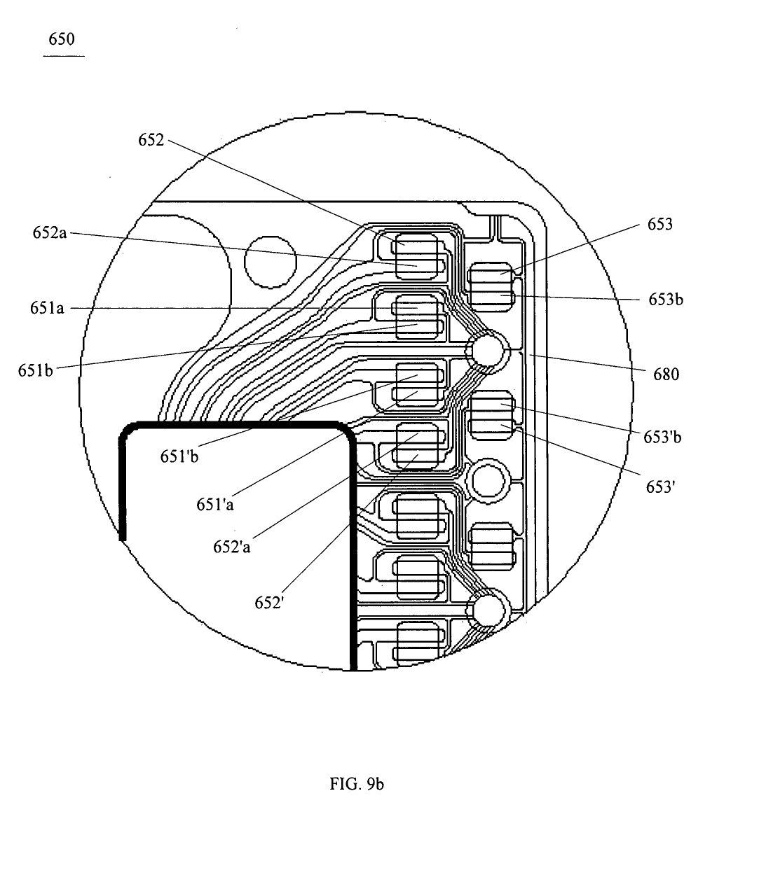

FIGS. 9a-9b illustrate a flexible printed cable 600 according to the present invention for connecting a group of stacked head gimbal assemblies mentioned above with a control system. The flexible printed cable 600 comprises a top portion 650 having a plurality of connection terminals for connecting to the respective head gimbal assemblies and an end portion 660 opposite the top portion 650 for connecting to the control system. The flexible printed cable 600 further comprises one common voltage lead 680 (referring to FIG. 9b) for transmitting micro-actuator drive voltage. Referring to FIG. 9b, in this embodiment, the top portion 650 of the flexible printed cable has a plurality of connection terminals. The connection terminals of the top portion 650 respectively have a signal-control pad 653/653′, a slider flying height adjustment pad 652/652′, a pair of read differential pads 651b/651′b, 651a/651′a and a pair of write differential pads 652a/652′a, 653b/653′b. The signal-control pad 653/653′ is adapted for establishing electrical connection with the corresponding micro-actuator through the signal-control lead 553 and the inner trace 433′. The signal-control pads 653, 653′ of the connection terminals are connected to the common voltage lead 680. Such configuration saves the space for the flexible printed cable 600 and enables to reduce the size of the flexible printed cable 600 greatly.

In the subject embodiment, each of the connection terminals has three windows, one window accommodates one read differential pad 651a/651′a and the other read differential pad 651b/651′b, another window accommodates one write differential pads 652a/652′a and the slider flying height adjustment pad 652/652′ and still another window accommodates the other write differential pad 653b/653′b and the signal-control pad 653/653′.

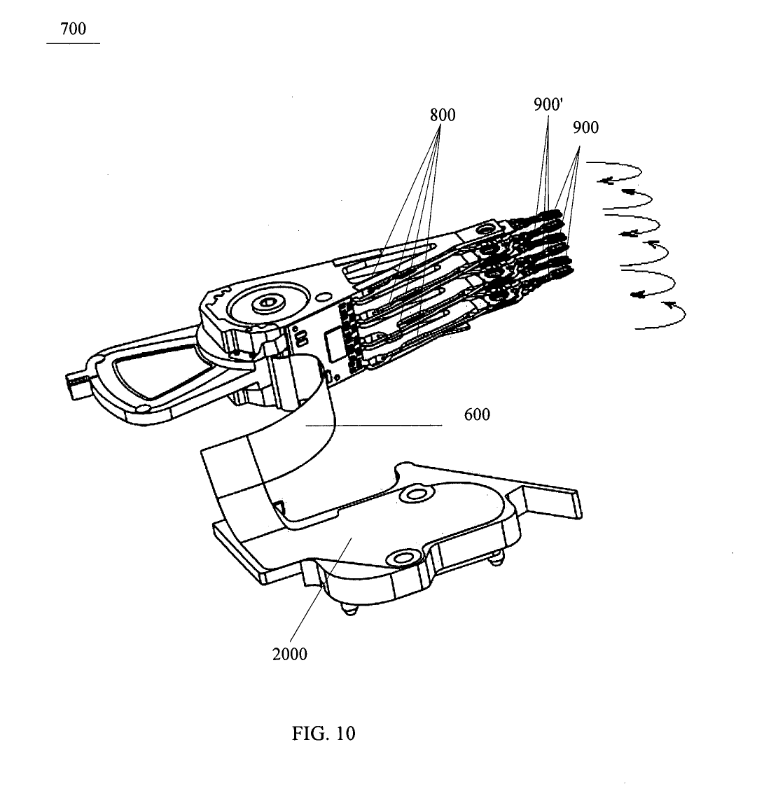

FIGS. 10-15 illustrate a head stack assembly 700 according to the present invention. Referring to FIG. 10, the head stack assembly 700 comprises a plurality of drive arms 800, a group of up-face head gimbal assemblies 900′ facing upward, a group of down-face head gimbal assemblies 900 facing downward, and a flexible printed cable 600 which is coupled to a connector 2000 for electrically controlling the operation of all the head gimbal assemblies 900′, 900. The configuration of the flexible printed cable 600 is featured as mentioned above. The up-face and the down-face head gimbal assemblies 900′, 900 are connected to the drive arms 800 in such a manner that the up-face head gimbal assemblies 900′ and the down-face head gimbal assemblies 900 are alternately arranged and stacked.

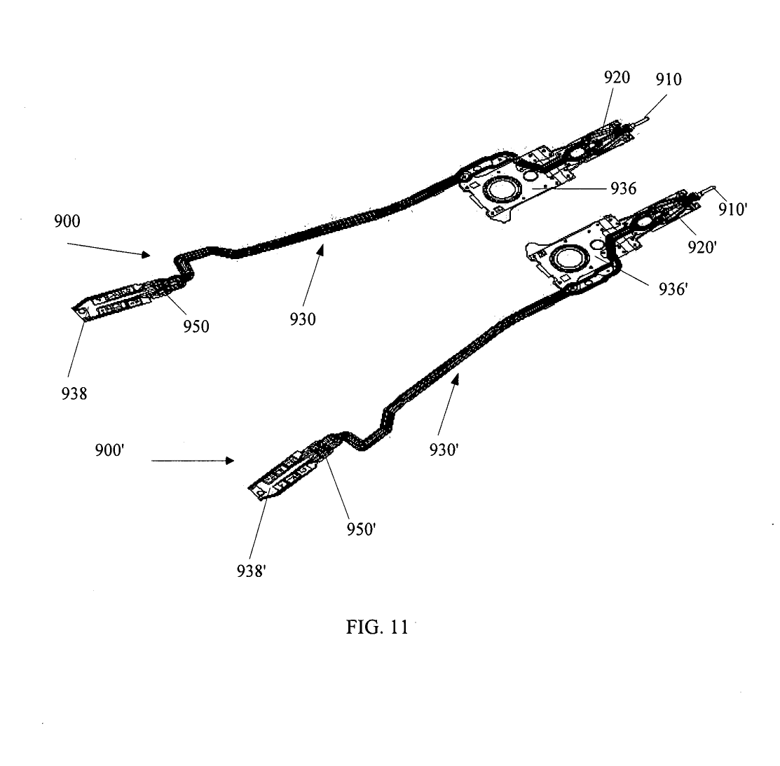

Referring to FIG. 11, each head gimbal assembly 900/900′ comprises a slider 910/910′, a micro-actuator 920/920′ with two piezoelectric elements of opposite polarization, and a suspension 930/930′ having a top portion 936/936′ and a tail portion 938/938′. The slider 910/910′ and the micro-actuator 920/920′ are disposed on the top portion 936/936′. The tail portion 938/938′ has a bonding terminal 950/950′ electrically connected with the flexible printed cable 600. The suspension 930/930 provides a single channel electrically connecting the bonding terminal 950/950′ with the micro-actuator 920/920′. The up-face head gimbal assemblies 900′ and the down-face head gimbal assemblies 900 have a relation that if align the up-face head gimbal assemblies 900′ and the down-face head gimbal assemblies 900 in the same direction, the piezoelectric elements and the channels of all the head gimbal assemblies 900′/900 are same Thus when in operation, the driving voltage will make the micro-actuators 920/920′ of the down-face/up-face head gimbal assemblies 900/900′ rotate in oppose direction. The rotation forces in oppose direction cancel each other, which prevents suspension vibration resonance and arm vibration resonance, thus significantly avoiding the slider off-track and out of TMR budget.

According to the principle of the present invention, each of the micro-actuators 920/920′ provides two pads respectively formed on corresponding piezoelectric elements and both electrically connected with the corresponding bonding terminal 950/950′ thus forming the corresponding single channel.

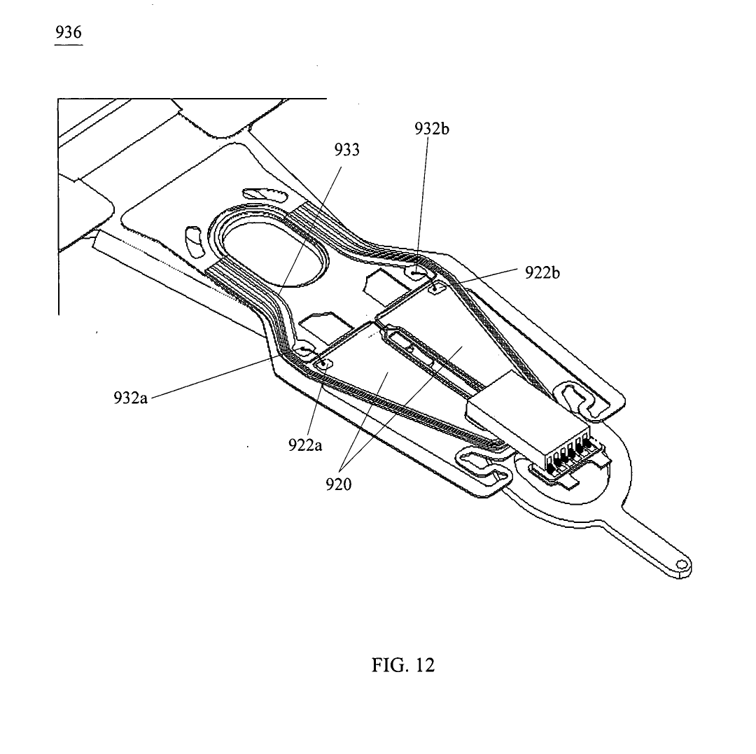

In the subject embodiment, the micro-actuator of each of the down-face/up-face head gimbal assemblies 900/900′ provides a ground pad and a signal-input pad. Take the down-face head gimbal assembly for illustrated, referring to FIG. 12, the micro-actuator 920 provides a ground pad 922b and a signal-input pad 922a. The suspension 930 forms two pads 932a, 932b according to the ground pad 922b and the signal-input pad 922a of the micro-actuator 920. A single inner trace 933 connects the pad 932a and the signal-input pad 922a to establish the single channel.

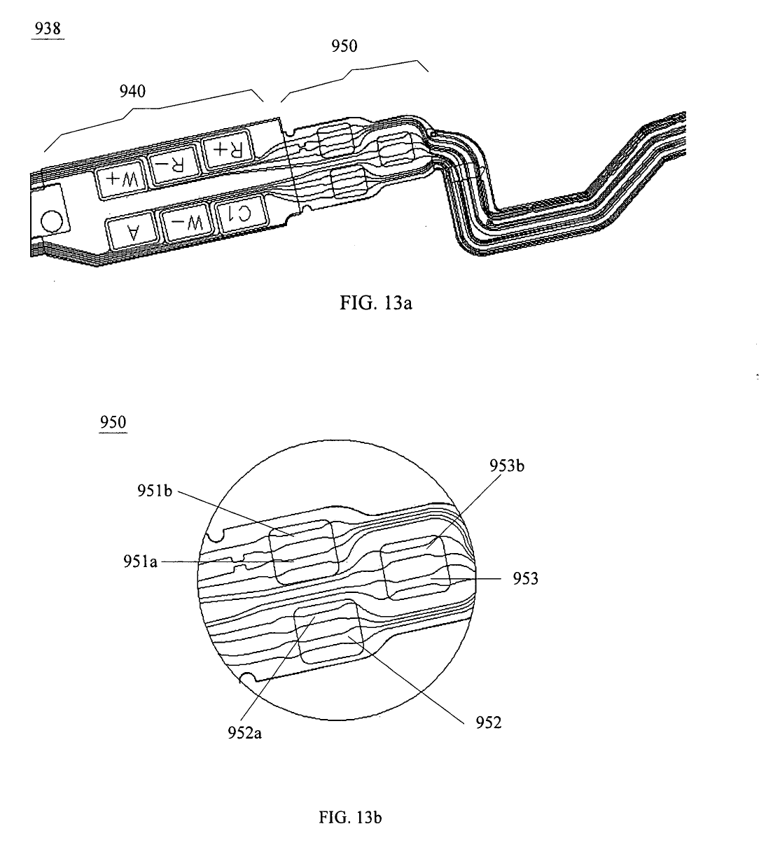

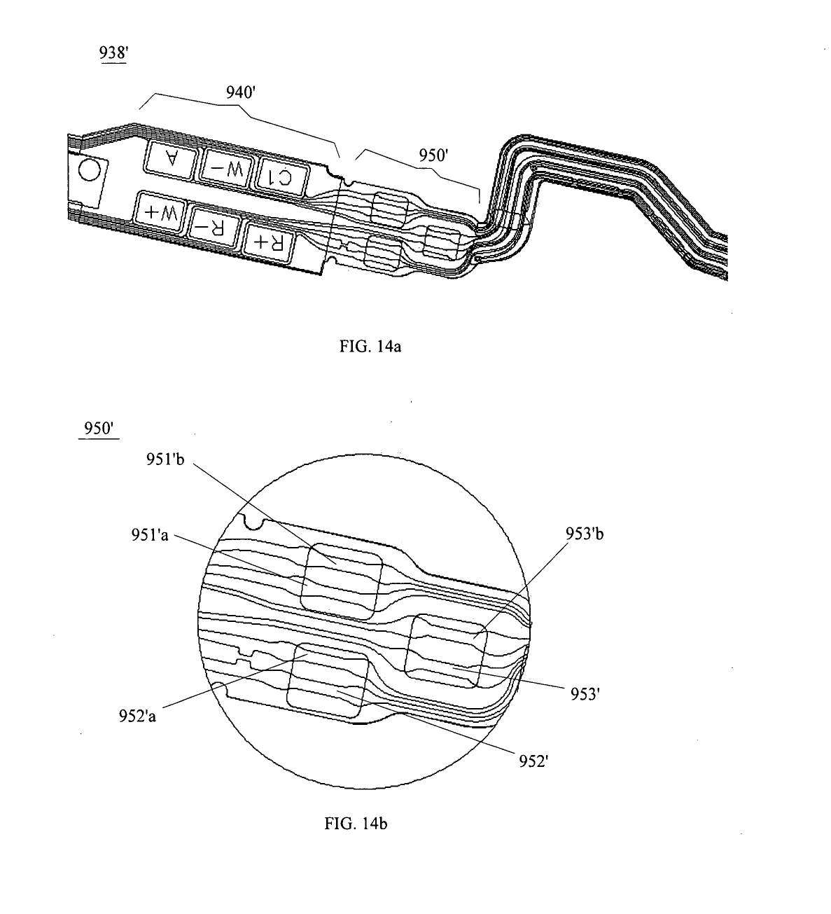

Referring to FIGS. 13a and 14a, the tail portion 938/938′ of each of the down-face/up-face head gimbal assemblies 900/900′ has a testing-pad terminal 940/940′ and a bonding terminal 590/950′. The testing-pad terminal 940/940′ has a plurality of pads which is used for testing dynamic performance of the head gimbal assembly 900/900′. After finishing the testing, the testing-pad portion 940/940′ will be cut off and removed before the coupling of the tail portion 938/938′ with the flexible printed cable 600. The bonding terminal 950/950′ is adapted for establishing electrical connection with the flexible printed cable 600.

Referring to FIGS. 13b and 14b, the bonding terminal 950/950′ of each of the down-face/up-face head gimbal assemblies 900/900 provides a signal-control lead 953/953′ connected to the micro-actuator 920/920′, a slider flying height adjustment lead 952/952′, a pair of read differential leads 951a/951′a, 951b/951′b, and a pair of write differential leads 952a/952′a, 953b/953′b. The slider flying height adjustment lead 952/952′, the pair of read differential leads 951a/951′a, 951b/951′b and the pair of write differential leads 952a/952′a, 953b/953′b electrically connect to the corresponding slider 910/910′ respectively. In the embodiment, the bonding terminal 950/950′ has three windows. One window accommodates one read differential lead 951a/951′a and the other read differential lead 951b/951′b, another window accommodates one write differential leads 952a/952′a and the slider flying height adjustment lead 952/952′, and still another window accommodates the other write differential lead 953b/953′b and the signal-control lead 953/953′. The signal-control lead 953/953′ is laminated between the pair of write differential leads 953b/953′b, 952a/952′a.

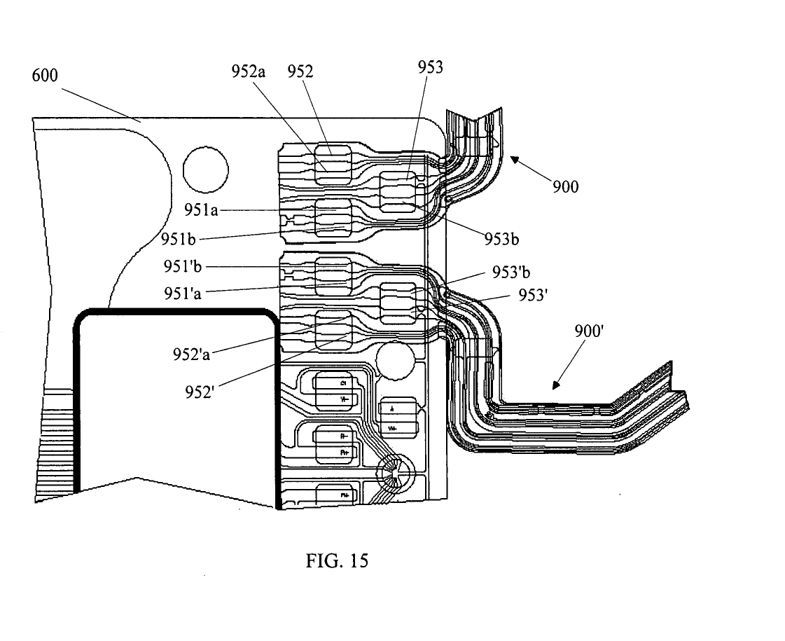

As illustrated, the flexible printed cable 600 is featured as mentioned above. FIG. 15 is a view showing the tail portion 950 of the down-face head gimbal assembly 900 of FIG. 13b and the tail portion 950′ of the up-face head gimbal assembly 900′ of FIG. 14b assembled with the top portion 650 of the flexible printed cable 600. In assembly, the signal-control leads 953/953′ connect with the respective signal-control pads 653/653′, the pairs of read differential leads 951a/951′, 951b/951′b connect with the respective pairs of read differential pads 651a/651′a, 651b/651′b, the pairs of write differential leads 952a/952′a, 953b/953′b connect with the respective pairs of write differential pads 652a/652′a, 653b/653′b, and the slider flying height adjustment leads 952/952′ connect with the respective slider flying height adjustment pads 652/652′. The single channel of down-face head gimbal assembly 900 for controlling its micro-actuator is formed by electrically connecting the signal-control pad 653, the signal-control lead 953, and the signal-input pad 932a. The single channel of up-face head gimbal assembly 900′ for controlling its micro-actuator is formed by electrically connecting the signal-control pad 653′, the signal-control lead 953′, and the signal-input pad of itself.

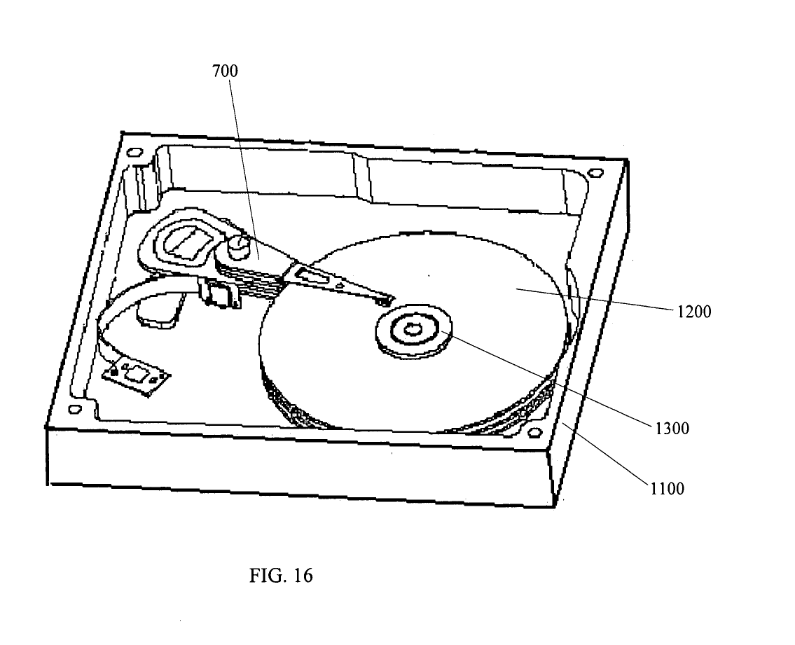

FIG. 16 is a perspective view of a disk drive unit according to the invention. The disk drive unit can be attained by assembling a housing 1100, a stack of disks 1200, a spindle motor 1300 for spinning the disks 1200, and the head stack assembly 700 of the present invention. Because the structure and/or assembly process of disk drive unit of the present invention are well known to persons ordinarily skilled in the art, a detailed description of such structure and assembly is omitted herefrom.

The foregoing description of the present invention has been presented for purposes of illustration and description. It is not intended to be exhaustive or limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. A head gimbal assembly, comprising:
a micro-actuator with two piezoelectric elements of opposite polarization; and
a suspension having a top portion and a tail portion, the micro-actuator being disposed on the top portion, the tail portion having a bonding terminal adapted for establishing electrical connection with a flexible printed cable;
wherein the suspension provides a single channel electrically connecting the bonding terminal with the micro-actuator for controlling the movement of the micro-actuator.

2. The head gimbal assembly according to claim 1, wherein the micro-actuator provides only two pads respectively formed on corresponding piezoelectric elements and both electrically connected with the bonding terminal thus forming the single channel.

3. The head gimbal assembly according to claim 1, wherein the micro-actuator provides a ground pad and a signal-input pad respectively formed on corresponding piezoelectric elements, the bonding terminal provides only one signal-control lead, and the single channel is formed by electrically connecting the signal-control lead of the bonding terminal with the signal-input pad of the micro-actuator.

4. The head gimbal assembly according to claim 3, wherein the bonding terminal further provides a slider flying height adjustment lead, a pair of read differential leads and a pair of write differential leads, the signal-control lead is laminated between the pair of write differential leads.

5. A head gimbal assembly, comprising:
a slider;
a micro-actuator with two piezoelectric elements of opposite polarization; and
a suspension having a top portion and a tail portion, the slider and the micro-actuator being disposed on the top portion, the tail portion having a bonding terminal adapted for establishing electrical connection with a flexible printed cable, the bonding terminal providing a signal-control lead, a slider flying height adjustment lead, a pair of read differential leads and a pair of write differential leads, the signal-control lead electrically connecting to the micro-actuator, the slider flying height adjustment lead, the pair of read differential leads and the pair of write differential leads electrically connecting to the slider respectively;
wherein the signal-control lead is laminated between the pair of write differential leads.

6. The head gimbal assembly according to claim 5, wherein the bonding terminal has three windows, one window accommodates the pair of read differential leads, another window accommodates one of the pair of write differential leads and the slider flying height adjustment lead, and still another window accommodates the other write differential lead and the signal-control lead.

7. A flexible printed cable adapted for connecting a group of stacked head gimbal assemblies with a control system, each head gimbal assembly having a micro-actuator, the flexible printed cable comprising:
a top portion having a plurality of connection terminals adapted for connecting to the respective head gimbal assemblies, the connection terminals each having a signal-control pad adapted for establishing electrical connection with the corresponding micro-actuator;
an end portion opposite the top portion for connecting to the control system; and
one common voltage lead for transmitting micro-actuator drive voltage, all of the signal-control pads of the connection terminals connecting to the common voltage lead.

8. The flexible printed cable according to claim 7, wherein each of the connection terminals further has a slider flying height adjustment pad, a pair of read differential pads and a pair of write differential pads.

9. The flexible printed cable according to claim 8, wherein each of the connection terminals has three windows, one window accommodates the pair of read differential pads, another window accommodates one of the pair of write differential pads and the slider flying height adjustment pad, and still another window accommodates the other write differential pad and the signal-control pad.

10. A head stack assembly, comprising:
a plurality of drive arms;
a group of up-face head gimbal assemblies facing upward and a group of down-face head gimbal assemblies facing downward, the up-face and the down-face head gimbal assemblies being connected to the drive arms in such a manner that the up-face head gimbal assemblies and the down-face head gimbal assemblies are alternately arranged and stacked; and
a flexible printed cable for electrically controlling the operation of all the head gimbal assemblies;
wherein each of the head gimbal assembly comprises:
a slider;
a micro-actuator with two piezoelectric elements of opposite polarization; and
a suspension having a top portion and a tail portion, the slider and the micro-actuator being disposed on the top portion, the tail portion having a bonding terminal electrically connected with the flexible printed cable, the suspension providing a single channel electrically connecting the bonding terminal with the micro-actuator;
wherein the up-face head gimbal assemblies and the down-face head gimbal assemblies have a relation that if align the up-face head gimbal assemblies and the down-face head gimbal assemblies in the same direction, the piezoelectric elements and the channels of all the head gimbal assemblies are same.

11. The head stack assembly according to claim 10, wherein each of the micro-actuators provides only two pads respectively formed on corresponding piezoelectric elements and both electrically connected with the corresponding bonding terminal thus forming the corresponding single channel.

12. The head stack assembly according to claim 10, wherein each of the micro-actuators provides a ground pad and a signal-input pad, the bonding terminal of each of the head gimbal assemblies provides a signal-control lead, the flexible printed cable has a plurality of connection terminals for connecting to the respective head gimbal assemblies, the connection terminals each have a signal-control pad, the single channel of each head gimbal assembly is formed by electrically connecting the signal-control pad, the signal-control lead and the signal-input pad.

13. The head stack assembly according to claim 12, wherein each of the bonding terminals further has a slider flying height adjustment lead, a pair of read differential leads, and a pair of write differential leads; the slider flying height adjustment lead, the pair of read differential leads and the pair of write differential leads electrically connect to the corresponding slider respectively, the connection terminals of the flexible printed cable each further has a slider flying height adjustment pad connected to the slider flying height adjustment lead, a pair of read differential pads respectively connected to the pair of read differential leads, and a pair of write differential pads respectively connected to the pair of write differential leads.

14. The head stack assembly according to claim 13, wherein each of the bonding terminals has three windows, one window accommodates the pair of read differential leads, another window accommodates one of the pair of write differential leads and the slider flying height adjustment lead, and still another window accommodates the other write differential lead and the signal-control lead.

15. The head stack assembly according to claim 13, wherein each of the connection terminals of the flexible printed cable has three windows, one window accommodate the pair of read differential pads, another window accommodates one of the pair of write differential pads and the slider flying height adjustment pad, and still another window accommodates the other write differential pad and the signal-control pad.

16. The head stack assembly according to claim 13, wherein the signal-control lead is laminated between the corresponding pair of write differential leads.

17. The head stack assembly according to claim 12, wherein the flexible printed cable has one common voltage lead for transmitting micro-actuator drive voltage, all of the signal-control pads of the connection terminals connect to the common voltage lead.

18. A disk drive unit comprising:
a head stack assembly;
a stack of disks; and
a spindle motor operable to spin the disks;
wherein the head stack assembly comprises:
a plurality of drive arms;
a group of up-face head gimbal assemblies facing upward and a group of down-face head gimbal assemblies facing downward, the up-face and the down-face head gimbal assemblies being connected to the drive arms in such a manner that the up-face head gimbal assemblies and the down-face head gimbal assemblies are alternately arranged and stacked; and
a flexible printed cable for electrically controlling the operation of all the head gimbal assemblies;
wherein each of the head gimbal assembly comprises:
a slider;
a micro-actuator with two piezoelectric elements of opposite polarization; and
a suspension having a top portion and a tail portion, the slider and the micro-actuator being disposed on the top portion, the tail portion having a bonding terminal electrically connected with the flexible printed cable, the suspension providing a single channel electrically connecting the bonding terminal with the micro-actuator;
wherein the up-face head gimbal assemblies and the down-face head gimbal assemblies have a relation that if align the up-face head gimbal assemblies and the down-face head gimbal assemblies in the same direction, the piezoelectric elements and the channels of all the head gimbal assemblies are same.
